(19) United States
(12) Patent Application Publication
(10) Pub. No.: US 2002/0098265 A1
(43) Pub. Date: Jul. 25, 2002

(54) Method of processing starch grain material and method of manufacturing fermented product using the processed material

(75) Inventors: Yasuo Konishi, Osaka (JP); Shigeo Tani, Kyoto (JP); Masaaki Uozumi, Tokushima-ken (JP); Takeharu Miyamoto, Tokushima-ken (JP)

Correspondence Address: Russell D. Orkin, 700 Koppers Builing, 436 Seventh Avenue, Pittsburgh, PA, 15219-1818, US

(73) Assignee: KONISHI FERMENTATION RESEARCH LAB. PTY., LTD.

(21) Appl. No.: 10/035,487

(22) Filed: Oct. 19, 2001

(30) Foreign Application Priority Data
Oct. 20, 2000 (JP) 2000-320880

(51) Int. Cl. A23L 1/20

(52) U.S. Cl. 426/46; 426/241; 426/240

(57) ABSTRACT

A method of processing starch grain material for use in a fermenting process subsequently thereto is disclosed. Prior to subjecting the material to the fermenting step, the material is subjected to a microwave irradiating step and this microwave irradiating step is effected on the starch grain material which is in a dry condition storable at a room temperature with simultaneous application of hot air current thereto. A method of manufacturing a fermented product using the material processed by the method above is also disclosed.

### BACKGROUND OF THE INVENTION

1. Field of the Invention

The present invention relates to the art of fermenting starch grain material. The invention relates, more particularly, to a method of processing starch grain material before putting it to a fermenting step for fermenting the material to obtain a fermented product such as various alcoholic drinks or fermented food products (generically “fermented products” hereinafter). The invention relates also to a method of manufacturing such fermented product by using the material processed by the above method.

Here, the term “starch grain material” refers to such starch materials in the form of grains including husked rice, white rice, barley, wheat, corn, barnyard grass seed, millet seed, kaoliang or sorghum (corn of Chinese origin), tubers including tapioca, sweet potato, and beans including soybean, adzuki bean, etc. The term is used to encompass all such materials that have the so-called starch grain structure. The materials may be in any form including not only their natural forms but also their powder form.

2. Description of the Related Art

The typical conventional method of processing starch grain material, taking the case of using rice as raw material for various fermented products (e.g. Japanese “sake”, “shochu” (white distilled liquor), “mirin” (sweet seasoning sake), “amazake” (sweet drink made from fermented rice)) for instance, the material is subjected to a series of preliminary steps of milling husked rice, washing, soaking, and steaming, etc. before it is subjected to the fermenting process.

At present, the above-described method is still employed. In recent years, however, in order to cope with need for ever increasing diversity of fermented products and higher manufacture efficiency, a variety of improvements have been proposed in the art of processing starch grain material.

An example of the above is a method of processing starch grain material utilizing microwave irradiation. According to the typical process of this conventional method, starch grain material is washed in water and soaked therein to absorb water. Thereafter, this material is subjected to microwave irradiation.

With the above method, however, by fermenting the starch grain material after subjecting it to the water washing and soaking steps for absorbing water, the flavor of material may be improved, but the utilization efficiency or factor of the material is not so high.

The present invention has been made in view of the above-described state of the art and its primary object is to provide a method of processing starch grain material utilizing microwave irradiation, which method provides improvement in the material utilization efficiency.

### Summary of the Invention

For accomplishing the above-noted object, according to a first characterizing feature of the present invention, there is proposed a method of processing starch grain material for use in a fermenting process subsequently thereto, wherein prior to subjecting the material to a fermenting step, the material is subjected to a microwave irradiating step, and wherein the microwave irradiating step is effected on the starch grain material which is in a dry condition storable at a room temperature with simultaneous application of hot air current thereto.

With the processing method having the first feature described above, the starch grain material in its dry state is irradiated by microwave while hot air current is being applied thereto simultaneously. Therefore, moisture transpired from the inner side of the starch grain material can be readily dissipated from the starch grain material layer without stagnating on the surface of the material. As a result, the moisture distribution of the starch grain material may be rendered uniform, so that the microwave may be irradiated uniformly from the inner side through the outer side of the material. That is, the feature achieves uniform microwave irradiation of the entire starch grain material.

With such uniform microwave irradiation of the entire material, the irradiated microwave can provide its various effects to the entire material such as formation of numerous micro fissures from the inner side through the outer side of the starch grain material.

With such uniform manifestation of the microwave irradiation effects over the entire starch grain material, in the case of a manufacturing method of a fermented product for example, it becomes possible to promote generation of alcohol when the material is subjected to the fermenting step after the microwave irradiating step and also to reduce occurrence of scorching during the microwave irradiating step as well as to improve the efficiency of microwave irradiation. Consequently, the material utilization efficiency can be further improved.

Further, with such uniform microwave irradiation of the entire material, in the method of manufacturing a fermented product, even if the material is then subjected directly to the fermenting process without such preliminary steps as steaming, roasting, liquefying, etc., it is still possible to generate a sufficient amount of alcohol and to achieve high material utilization efficiency. In addition, it is also possible to simplify the manufacturing process and to improve the manufacture efficiency.

Incidentally, even if the dried starch grain material after the above-described microwave irradiating step is subjected directly to the fermenting process, the possibility of e.g. change due to mixing of other microorganisms is low since the entire starch grain material has already been sterilized through the microwave irradiating step. Hence, it is not necessary to carry out a sterilizing step separately, so that the energy consumption can be reduced and the manufacturing process can be further simplified.

According to a second characterizing feature of the present invention, in addition to the first characterizing feature described above, the starch grain material comprises rice grains and at least a portion of the rice grains are used directly as sake-brewing rice without being subjected to a water-soaking step, steaming step, liquefying step or roasting step.

With the second characterizing feature above, the starch grain material comprises rice grains and at least a portion of the rice grains are used directly as sake-brewing rice without being subjected to a water-soaking step, steaming step, liquefying step or roasting step. Thus, in the manufacture of sake or shochu as an example of fermented product, even if the dried rice grains after the microwave irradiating step are used directly under the dried condition in the subsequent fermenting process, without subjecting them in advance to such steps as not only the water-soaking step and steaming step, but also as the liquefying step and roasting step, alcohol can be yielded at a sufficiently high rate. And, the material can be utilized very efficiently. Whereby, the manufacture process can be even further simplified and the manufacture efficiency can be further improved.

According to a third characterizing feature of the invention, in addition to the first characterizing feature described above, the starch grain material comprises starch grain material for “koji” (koji is steamed rice that has koji mold spores cultivated on it), and this koji material is mixed with water containing koji mold spores to a moisture content of 25 to 40% and the resultant mixture is adjusted to a temperature suitable for growth of the koji mold spores so as to obtain koji.

With the method having the third characterizing feature described above, the starch grain material comprises starch grain material for koji, and this koji material is mixed with water containing koji mold spores to a moisture content of 25 to 40% and the resultant mixture is adjusted to a temperature suitable for growth of the koji mold spores so as to obtain koji. The following advantages are achieved.

That is, as described hereinbefore, with the uniform application of the microwave irradiation to the entire koji starch grain material, the various effects of the microwave irradiation may be provided to the entire koji starch grain material, such as formation of micro fissures from the inner through outer portions of the material. Therefore, by subsequently adding to this material water containing koji mold spores to a moisture content of 25 to 40% and then adjusting the resultant mixture to a temperature suitable for growth of the koji mold spores (about 35 to 40° C.), koji comprising the material containing the koji mold bred therein may be manufactured easily without such additional steps as steaming the koji starch grain material.

Further, depending on the addition amount of water containing the koji mold spores, the enzyme activity or enzyme composition of the resultant koji will vary. Therefore, the addition amount of water should be suitably adjusted, depending on the type of fermented product to be obtained. In this respect, however, in order to obtain predetermined enzyme activity and enzyme composition, the water content of the koji starch grain material should range preferably between 25 and 40%. An example of this is shown in Table 1 below.

TABLE 1

| water | | | |
|---|---|---|---|
| content | α-amylase | glucoamylase activity | acidic protease activity |
| (%) | (U/g koji) | (mg glucose/hr/g koji) | (μg tyrosine/hr/g koji) |
| 26 | 1,405 | 235 | 3,171 |
| 29 | 1,010 | 246 | 3,473 |
| 32 | 997 | 170 | 2,453 |

### BRIEF DESCRIPTION OF THE DRAWINGS

FIG. 1 is an explanatory view of an example of a processing apparatus used in an invention's method of processing starch grain material,

FIGS. 2 and 3 are explanatory views relating to temperature variations in the starch grain material processed by the method relating to the present invention,

FIG. 4 is an explanatory view relating to a fermentation rate of the starch grain material processed by the method relating to the present invention, and

FIG. 5 is an explanatory view relating to conditions of the starch grain material processed by the method relating to the present invention.

### DESCRIPTION OF THE PREFERRED EMBODIMENTS

Preferred embodiments of the present invention relating to a method of processing starch grain material will be described in detail with reference to the accompanying drawings as well as to some specific examples.

In the following discussion, for facilitating distinction between a processing method according to the present invention and a processing method according to the prior art, the former will be referred to as “invention's processing method” and the latter as “conventional processing method”, respectively.

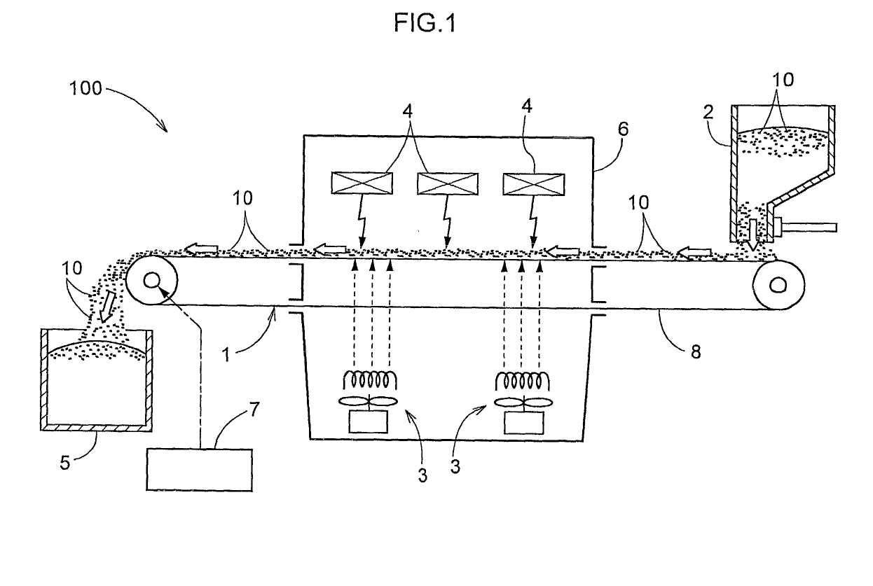

First, with reference to its schematic figure in FIG. 1, there will be described construction of a processing apparatus 100 as an example of a microwave irradiating apparatus for use in the invention's method of processing starch grain material.

As shown in FIG. 1, this processing apparatus 100 includes a belt conveyer 1, a starch grain material feeding device 2 disposed above the belt conveyer 1 for feeding starch grain material 10 onto the belt conveyer 1, a sheath 6 made of stainless steel for covering the starch grain material 10 fed on the belt conveyer 1, a hot air blower 3 mounted within the sheath 6 downwardly of the conveyer 1, the blower being capable of feeding hot air current against the starch grain material 10 being conveyed, and microwave irradiating units 4 mounted also within the sheath 6 upwardly of the conveyer 1, the irradiating units being respectively capable of continuously irradiating microwave to the starch grain material 10. In operation, the apparatus carries out a microwave irradiating process in which microwave is irradiated to the starch grain material 10 while the hot air current is being blown against it at the same time.

On the downstream of the belt conveyer 1, there is provided a starch grain material collecting device 5 for collecting the processed starch grain material 10 after the microwave irradiating process. And, also a conveying-speed control device 7 is provided for appropriately adjusting the operating speed of the belt conveyer 1. Incidentally, arrangement is made so that the microwave transmitted through the belt conveyer 1 may be reflected by the sheath 6 or if desired, a microwave reflector (not shown) is provided for irradiating the microwave again to the starch grain material 10.

With the above-described construction, the entire starch grain material 10, as being conveyed on a belt 8 of the belt conveyer 1, from its inner portion through the outer portion can be subjected to the microwave irradiation in a uniform fashion advantageously.

More particularly, to the above end, the belt 8 of the belt conveyer 1 comprises a single-layered belt so as to readily allow the starch grain material 10 to be exposed to the atmosphere for efficient and instantaneous transpiration of moisture from the inside of the material 10 when irradiated by the microwave. Moreover, this single belt is formed of the Teflon® material in the form of mesh for permitting speedy dissipation of the moisture from the surface layer of the starch grain material 10 on the face of the belt 8.

The hot air blower 3 is adapted for generating hot air atmosphere providing a hot air current flowing from the lower side to the upper side of the starch grain material 10 conveyed on the belt 8 so as to keep the vicinity of the material 10 at 50° C. to 120° C. Further, the blower 3 is adapted also to keep the vicinity of the belt 8 surface at 70° C. or higher so as to inhibit stagnation of vapor transpired from the inside of the material on the surface of the material, which stagnation would lead to gelation of the surface of the starch grain material, eventually formation of gel-like substance.

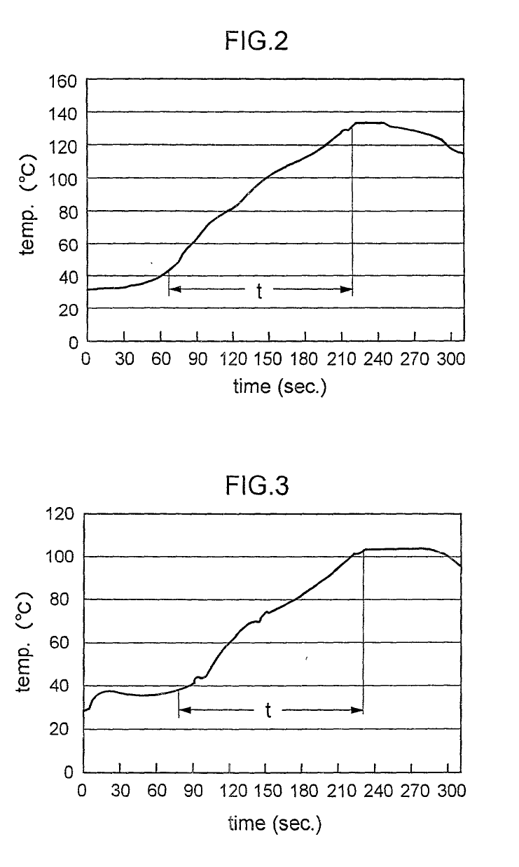

As an example, FIG. 2 shows temperature variation developed in raw rice (white rice) when the invention's processing method was conducted on this raw rice for irradiating microwave to it with simultaneous application of hot air current thereto while the rice was being conveyed on the belt 8 having thickness of 15 mm, width of 300 mm and a processing length of 7 m, At the beginning of the process, the white rice had temperature of 27° C. and moisture content of 12.5%, then the rice had temperature of 140° C. and moisture content of 10% or lower after the process.

As a comparison example, the conventional processing method was carried out in which only microwave was irradiated without simultaneous application of hot air current. The temperature variation in the raw rice in this conventional process is shown in FIG. 3. Incidentally, in these FIGS. 2 and 3, a period (t) denoted with an arrow is a period during which the raw rice was heated by the invention's method or the conventional method.

As shown in FIG. 2, in the case of the invention's processing method, in the period (t), the temperature of raw rice rose substantially in uniform proportion with the time lapse. And compared with the result shown in FIG. 3 relating to the conventional method as the comparison example, the rate of increase of the temperature was greater and the maximum temperature was higher in the case of the invention's method. Further, in the case of the conventional processing method as the comparison example, the temperature of raw rice rose in proportion with the time lapse until it reached about 70° C. and thereafter the temperature remained at about 70° C. for a while, and then it rose again in proportion with the time lapse, but at a lower rate than the previous rate at which it had reached about 70° C. And, it was confirmed that in the case of the conventional processing method the vapor from the inside of the raw rice stagnated on the surface of the rice, forming gel-like substance thereon.

Further, also from comparison between the temperature variations in the raw rice after the respective processes (i.e. the temperature variation after the period (t)) of the present invention and of the convention, the difference in the conditions of the raw rice can be seen. Namely, comparing the period when the temperature of the processed rice began to drop from the maximum temperature, the temperature began to drop much earlier in the case of the invention's method than the conventional method. From this fact too, it may be understood that according to the invention's processing method, gel-like substance is hardly formed on the surface of rice and the vapor is dissipated into the hot air atmosphere around the rice without being stagnated on the rice surface.

That is, according to the invention's method, microwave is irradiated to raw rice with simultaneous application of hot air current thereto, so that the temperature developed in the rice when irradiated by the microwave is allowed to rise rapidly without being stagnated at the gelation temperature (about 75° C.) of the raw rice and with no stagnation of vapor transpired from the inside of the rice, the gel-like substance is hardly formed on the rice surface.

Therefore, according to the inventions processing method, with microwave irradiation in the hot air atmosphere generated in the above-described manner, the hot air atmosphere promotes evaporation of the vapor transpired from the inside of the starch grain material, thereby to reliably inhibit stagnation of the vapor on the material surface and immediate dissipation thereof from the material. As a result, it is possible to effect the uniform microwave irradiation to the starch grain material in an even more reliable manner.

The invention's method of processing starch grain material for fermentation is not limited to the process using the particular processing apparatus 100 having the above-described construction. This processing apparatus 100 is merely an example of apparatuses which can be employed by the invention's method. Rather, the essential requirement of this apparatus is that the apparatus is capable of providing uniform microwave irradiation to the entire grain material by irradiating microwave to the dry starch grain material storable at a room temperature and capable also of applying hot air current thereto simultaneously.

Next, the invention's method of processing starch grain material will be described in greater details, with reference to some specific examples in which the inventions method was implemented experimentally with using the processing apparatus 100 having the above-described construction.

### EXAMPLE 1

A fermenting experiment was conducted after implementing a processing method of the invention of processing starch grain material for use in a subsequent fermenting process for producing a fermented product. For this experiment, the invention's method was carried out on white rice as an example of starch grain material by using the above-described processing apparatus 100. Specifically, according to the invention's method, the microwave irradiating process was effected on the dry white rice which can be stored at a room temperature (i.e. raw rice) with simultaneous application of hot air current thereto.

Separately, similar fermenting experiments were conducted on white rice processed by some conventional methods. And, raw material utilization factors of the respective methods were compared with each other. The conventional methods comprise method A, method B, method C and method D described below.

method A: method effecting only microwave irradiation on raw race;

method B: method using raw rice directly without effecting any process thereon (in this case, however, the raw rice employed had moisture content of 5.4%);

method C: method effecting α-processing of white rice by steaming it (so-called pregelatinizing process for steamed rice involving soaking, cooking for α-processing its starch and then rapid drying for long life and instant serving: moisture content 13.5%);

method D: method effecting microwave irradiation on rice which has been washed and soaked in water (the raw rice before the microwave irradiation has a moisture content of about 35%).

The white rice materials processed respectively by the invention's method, method A, method B, method C and method D were used as steamed rice in the fermenting experiments, using the fermenting blend shown in Table 2 below as the basic blend. As for the fermenting water, since the processed white rice materials (raw rice) had moisture contents different from each other, adjustments were made, with 13.5% being used as the basic moisture content of white rice. The temperature was fixed at 18° C. at the start of fermentation, 16° C. on the second day, at 13 to 15° C. on the third day and thereafter, and the fermentation was carried out for 14 to 16 days. Upon completion of the fermentation, solids and liquid were centrifugally separated and the components of the produced sake were put to analysis. Table 3 below shows the yields of pure alcohol (L/t) and the ratio (%) of sake lees (byproduct of sake) for each of the methods above.

TABLE 2

| | |
|---|---|
| total rice (g) | 500 |
| steamed rice (sake-brewing rice) (g) | 400 |
| koji (g) | 100 |
| fermenting water (ml) | 950 |
| yeast culture solution (ml) | 0.75 |

TABLE 3

| | invention’s | method | method | method | |
|---|---|---|---|---|---|
| | method | A | B | C | method D |
| amount of pure | 384 | 294 | 228 | 328 | 358 |
| alcohol yielded | | | | | |
| (L/t) | | | | | |
| ratio of sake lees | 20.2 | 34.5 | 62.9 | 30.0 | 39.0 |
| (%) | | | | | |

As may be seen from Table 3 above, the invention's processing method achieved higher yield of alcohol, lower ratio of byproduct, i.e. sake lees and higher material utilization factor (100% ratio of sake lees (%)) than any of the conventional methods of methods A through D.

### EXAMPLE 2

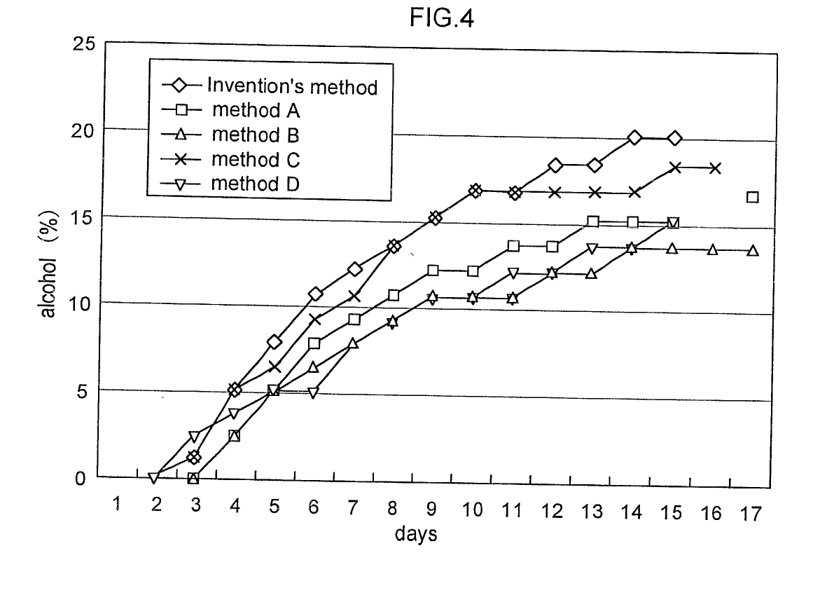

Next, by a fermentation experiment similar to that of Example 1, fermentation processes of the various methods were investigated. The results are shown in FIG. 4.

As may be understood from FIG. 4, with the invention's processing method, the alcohol yield during the fermenting process (determined by way of weight reduction due to generation of carbonic acid gas with adjustment of amount of moisture evaporated) was greater than any of the methods A-D and the material utilization ratio was higher as well.

Incidentally, with the invention's processing method, the fermenting rate during the fermenting process is superior to the prior art and the fermenting process is stable. Therefore, if a situation requires the so-called multi-stage fermentation for feeding the material in some portions, with the method of the invention, this can be coped instead with a single-stage fermentation, with which sufficient fermentation effect can still be obtained.

As described above, Examples 1 and 2 demonstrate that the invention's processing method can achieve a higher material utilization factor than not only method B in which raw rice is used directly without any additional processing, but also the conventional methods A, D and the rice-steaming method, i.e. method C. The possible reason for this is as follows.

When microwave is irradiated to starch grain material, rapid moisture evaporation tends to occur from the inner side of the starch grain material. However, the generated vapor tends to be stagnated in the vicinity of the outer surface of the material, leading to non-uniform moisture distribution within the starch grain material. In the case of the conventional processing method using only the microwave irradiation, the effect of the microwave irradiation cannot be provided uniformly throughout the material from its inner side to the outer side.

For this reason, with the conventional method, gelatinization on the starch grain material surface is promoted, resulting in formation of hard gel-like substance. Hence, the method is unable to form micro fissures into the depth of the material, forming instead non-uniform or large fissures or cracks therein. All these tend to interfere with the workings of the yeast and there tends to occur unevenness in the effect of the microwave irradiation, tending to invite scorching during the microwave irradiation as well as deterioration in the effect of the microwave irradiation. Consequently, the material utilization factor suffers. This is the possible reason for the lower material utilization factor in the case of the conventional method.

On the other hand, according to the invention's processing method, the microwave irradiation to the starch grain material is carried out with simultaneous application hot air current thereto. With this, the vapor transpired from the inner side of the material is immediately dissipated or removed away of the material surface by the hot air current delivered against the material. And, the moisture distribution in the starch grain material is rendered uniform and the effect of microwave irradiation is provided uniformly throughout the starch grain material from its inner side to the outer side.

Further, as the microwave is irradiated to the dry starch grain material (e.g. raw rice) storable at a room temperature, the material does not contain much moisture from the beginning, prior to the microwave irradiation thereto. Therefore, the disadvantageous stagnation of vapor on the material surface can be restricted even more, so that the moisture distribution within the starch grain material can be rendered even more uniform and the microwave can be irradiated even more uniformly to the entire material from its inner side to outer side.

Therefore, according to the invention's processing method, the microwave irradiation can be provided more uniformly throughout the starch grain material from its inner side to outer side. Hence, micro fissures can be formed in the entire material from its inner side to outer side throughout, providing advantageous conditions for working of koji and the yeast. And, other effects of the microwave irradiation too can be provided uniformly to the entire starch grain material. The method also restricts occurrence of scorching during the microwave irradiation and improves the efficiency of the irradiation as well. All these are believed to contribute to the improvement of material utilization ratio.

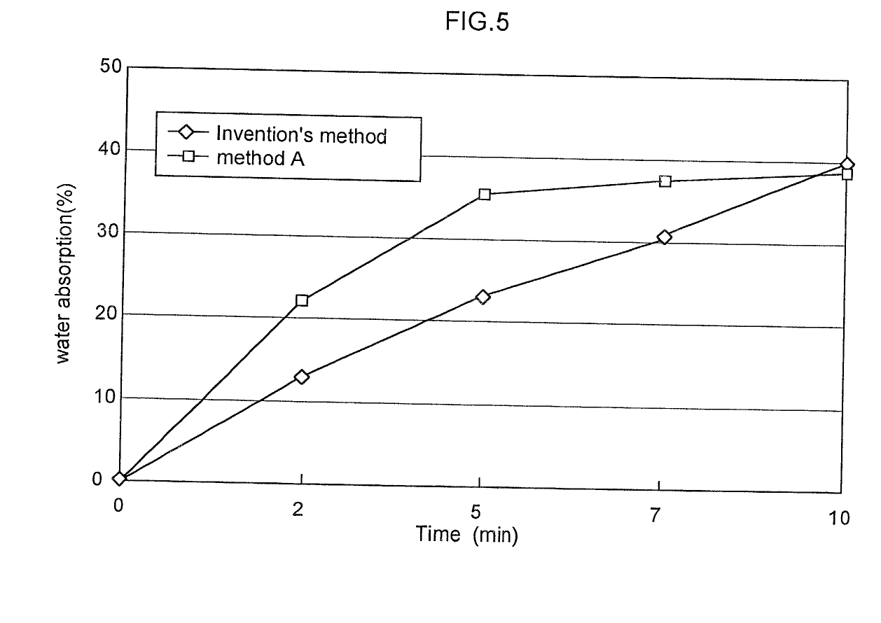

The ability of the invention's method of uniformly providing the various effects of microwave irradiation to the entire starch grain material is illustrated in a moisture-absorption-time graph of FIG. 5 showing moisture absorption by raw rice processed by the invention's method and method A, respectively.

As seen from FIG. 5, in the case of method A, the absorption rate rises rapidly within a short period and it remains substantially fixed thereafter. Whereas, in the case of the invention's method, the moisture-absorption rate rises substantially linearly with time. This is believed to be attributable to the fact that in the case of method A, the effect of the microwave irradiation is provided not uniformly, thus leading to formation of fissures or cracks of significantly different sizes and water can enter easily a large crack in particular, thus causing such rapid rise in the moisture-absorption rate. On the other hand, with the method of the invention, micro fissures are formed uniformly over the entire material, i.e. raw rice, so that water enters uniformly over the entire material, hence, the moisture-absorption rate rises substantially linearly with time.

### EXAMPLE 3

Digestion tests were conducted on the same various processing methods as in Example 1. The test results are shown in Table 4 below. In these digestion tests, to 10 g of each of the rice materials obtained by the various processing methods , 50 ml of 60 units/ml solution of enzyme: “GLUC S” (manufactured by Amano Pharmaceutical Co., Ltd.) was added and reaction was carried out at 30° C. for 24 hours (under presence of antiseptic agent).

TABLE 4

| | Baume degree | Brix degree |
|---|---|---|
| invention’s method | 4.6 | 10.3 |
| method A | 5.5 | 9.4 |
| method B | 3.6 | 6.0 |
| method C | 8.4 | 15.8 |
| method D | 5.4 | 9.8 |

As may be seen from Table 4 above, the methods using microwave irradiation, that is, the invention's method, method A and method D provide lower Brix degrees (reducing sugar amounts determined by Brix meter) in the digestion test liquids and also lower Baume degrees (values of densities of liquids determined by Baume's hydrometer) than method C. From this, it was found that these methods provide lower degrees of digestion at least under these test conditions. However, in the case of the invention's processing method, in spite of such low degree of digestion, from the results of Examples 1 and 2 described hereinbefore, it is believed that the material utilization factor and fermentation efficiency are still high. And, the following functions and effects can be expected.

That is in recent years, a variety of wild type yeast and koji mold have been isolated as valuable genetic resources. However, most of these are yeast or koji mold unsuitable for fermentation of digestive juice or saccharifying liquid prepared by e.g. steaming starch or cellulose for a higher degree of digestion. Hence, it has been difficult to put them to extensive use. With the invention's processing method, however, because of the lower digestion degree described above, these wild type yeasts which are generally regarded as unsuitable for use in the standard fermenting method of alcohols with higher degree of digestion can now be put to use extensively.

Incidentally, Examples 1-3 described above are just non-limiting examples for applying the method of the invention to processing of white rice as sake brewing rice. Needless to say, these examples should show that in addition to such white rice, the invention's method may be applied also to processing of other various starch grain materials and koji starch grain materials for fermentation. When applied to such other materials too, the invention's method can allow the various effects of microwave irradiation to be provided uniformly to the entire material. When the invention's method is implemented, such effects as improvement of material utilization factor and improvement of manufacture efficiency (brewing efficiency) can be obtained.

Next, the present invention will be described in further detail by way of some presently preferred embodiments thereof. Again, it is understood that the present invention is not limited to these particular embodiments.

(Embodiment 1)

As an example, the processing apparatus 100 shown in FIG. 1 was employed for effecting a microwave irradiating step in which microwave was irradiated to dry white rice (i.e. raw rice) (moisture content 14%) storable at a room temperature while hot air current of 100 to 105° C. was applied thereto simultaneously from the hot air blower 3. Then, this rice was subjected directly to a fermenting process, whereby refined Japanese sake was produced

In the microwave irradiating step, more particularly, the microwave of 2450 MHz was irradiated to the dry white rice storable at a room temperature (moisture content 14%) while the hot air current of 100° C. to 105° C. was applied simultaneously from the hot air blower 3 (when the temperature of the surface of the belt adjacent the white rice receiving the hot air current was about 70° C.), so as to obtain moisture content of 6.0% in the white rice. After this microwave irradiation, the temperature of the white rice was 130° C. to 140° C.

In this way, it was possible to carry out the microwave irradiation in an efficient manner, without causing scorching of the white rice.

To the resultant white rice after the microwave irradiation, appropriate amounts of water, alcohol generating yeast such as “shubo” (starter mash) and koji were added. Then, fermentation was carried out with fermentation blend shown in Table 5 below and the temperature was maintained at 15° C., whereby refined Japanese sake was produced.

TABLE 5

| | starter mash | single-stage fermentation |
|---|---|---|
| total rice amount (kg) | 20 | 340 |
| steamed rice (kg) | 15 | 280 |
| koji (kg) | 5 | 60 |
| fermenting water (L) | 25 | 620 |

In the above, in the case of the conventional method using only microwave irradiation, there is a tendency that white rice will precipitate in “moromi” (unrefined sake without removal of sake lees therefrom yet). Hence, the method would require constant stirring. In the case of the invention's method however, the density of the white rice is reduced after being processed by this method. So, unlike the conventional method, no constant stirring is needed in the case of the invention's method. Therefore, the operational efficiency was improved as well.

Incidentally, as described hereinbefore in the Examples, when the starch grain material processed by the invention's processing method is employed, the yeast grows rapidly. Therefore, the fermentation was effected in a single stage. Next, there will be described the amount of water, yeast and koji employed in the fermentation.

As for the so-called fermenting water to be added to white rice, in the case of the conventional method in which fermentation is carried out with increasing the digestion degree of white rice by means of steaming, roasting or liquefying, its degree is about 130%. On the other hand, when white rice processed by the invention's method is used, in the fermentation process, the alcohol generating rate is higher and the alcohol concentration tends to be correspondingly higher. Therefore, if the fermenting water ratio employed by the conventional method is used as it is, the stress experienced by the yeast from the alcohol concentration will be high. For this reason, it is preferred that the fermenting water ratio be higher than that employed in the conventional methods. Specifically, in case the fermenting water ratio of about 130% is appropriate in the case of the conventional method, this rate should be increased by 50% or more up to 180% or higher in the case of the invention's method.

As for the yeast, foamless strain of Yeast No. 9 (yeast registered and distributed by Japan Institute of Brewery) was used to separately brew starter mash and this was employed.

The koji employed was prepared as follows.

Under the same conditions as the microwave irradiating process on the white rice for fermentation, starch grain material for koji was subjected to microwave irradiation. Then, to the white rice as the koji starch grain material, water added with yellow koji mold spores was added, so that the koji white rice obtained moisture content of about 30%. Then, the temperature was adjusted to 35° C. which is suitable for growth of the yellow koji mold spores, whereby the target koji was obtained.

With the production of koji in the manner described above, the microwave irradiation may be readily provided uniformly over the koji white rice material. So that, such advantages as uniform formation of micro fissures from the inner side of the koji rice material may be obtained. Therefore, in comparison with the common practice for culturing koji by seeding koji mold to steamed koji material, koji mold may be grown uniformly over the entire white rice material for koji. Also, the temperature adjustment is easy. Hence, it is also possible to simplify the manufacturing process of manufacture of Japanese refined sake and to improve the manufacture efficiency.

Incidentally, in this embodiment, in the example thereof described above, the microwave irradiating process was carried out on the koji starch grain material under the same conditions as those employed for the microwave irradiating process on the fermentation starch grain material. In this case, it is possible to carry out the microwave irradiating process at one time to the fermenting white rice and the koji white rice for greater convenience. However, these conditions of the microwave irradiating process of the fermenting material and those for the koji material need not be the same, but may be appropriately determined, depending on a fermented product to be obtained. Further, in this embodiment, yellow mold spores for brewing refined sake were employed as koji mold spores. However, other kinds of the koji mold spores may be employed if suitable, such as black koji mold spores.

Also, in the present embodiment, in the example described above, the koji produced in the manner described above was employed in the fermentation. Alternatively, such commonly employed koji grown by seeding koji mold to the steamed koji starch grain material may be employed also. Needless to say, in such case too, if the fermentation starch grain material processed by the invention's method is employed in the fermenting process, the advantageous effects such as improved material utilization factor can be achieved.

With the fermenting process carried out as above, although the white rice after the microwave irradiation was used under the dry condition directly (without any additional process) in the subsequent fermentation, it was possible to carry out this fermentation in a stable manner with uniform sterilization of the entire white rice and less change thereof due to mixing of other microorganisms etc. afforded by the effects of the microwave irradiation.

And, an alcohol yield of 359.5 L/t and sake lees ratio of 35.0% were obtained. Hence, the material utilization factor was improved. Next, the other results will be described with reference to Tables 6 and 7 below.

TABLE 6

| | Japanese sake | alcohol | acid | amino acid | glucose |
|---|---|---|---|---|---|
| day | degree | (%) | degree | degree | (%) |
| 1 | | | | | |
| 2 | −16 | 3.5 | 1.2 | 0.3 | 1.99 |
| 3 | 2 | 7.5 | 2.3 | 0.55 | 0.46 |
| 4 | 11 | 11 | 2.3 | 1.1 | 0.15 |
| 5 | 8 | 13.1 | 2.9 | 1.5 | 0.81 |
| 6 | 16 | 14.8 | 2.7 | 1.5 | 0.05 |
| 7 | 9.5 | 15.7 | 2.7 | 1.85 | 1.16 |
| 8 | 16.5 | 16.8 | 2.7 | 2.05 | 0.48 |
| 9 | 21 | 18.1 | 2.7 | 2.2 | 0.03 |
| 10 | 19.5 | 18.3 | 2.65 | 2.1 | 0.29 |
| 11 | 18.5 | 18.7 | 2.8 | 2.4 | 0.53 |
| 12 | 22 | 19.1 | 2.7 | 2.3 | 0.05 |
| 13 | 22 | 19.5 | 2.5 | 2.4 | 0.04 |
| 14 | 25 | 19.5 | 2.5 | 2.85 | 0.01 |
| 15 | 25 | 19.8 | 2.4 | 2.7 | 0.01 |

TABLE 7

| isoamyl alcohol | isoamyl acetate | ethyl caproate |
|---|---|---|
| 543.6 | 11.3 | 0.55 |

As may be seen from Table 6 above, the white rice had been fermented sufficiently on the 12^{nd} day and this could be pressed to make refined Japanese sake. In this way, it was confirmed that the fermentation progressed well.

And, as an example, on the 12^{nd} day, the material was pressed and the degrees of generation of major flavor components such as isoamyl acetate ester were checked. As shown in Table 7 above, the results showed that for isoamyl acetate ester, a good value of 11.3 ppm was obtained. This is much superior not only to the rice-steaming process, but is as good as the conventional method using only microwave irradiation. And this value also far exceeds the value obtained with a very special brewing method called “dai-ginjo shikomi” (super brew fermentation) or with other special fermenting method using antibiotic resistant mutant (ester high producing amino acid analog resistant mutant). So, it was also demonstrated that the obtained refined sake had a very distinguished flavor.

Also, sensory tests were conducted. The results were satisfactory when using the invention's processing method in terms of “smoothness”. Hence, the product was found to be quite satisfactory in terms of taste as well.

The apparent glucose concentration was determined as about 2% at the earlier stage of the process and at 0.1% or lower on the 9^{th} day and thereafter, and the fermentation was progressing. Therefore, the method also allows extensive use of wild type yeasts which are considered to be unsuitable for use in the standard fermentation method with enhanced digestion degree.

As described above, with the invention's processing method, it is possible not only to improve the material utilization rate, but also to improve the flavor, smoothness, etc. In addition, during the fermenting process too, the rice after the microwave irradiation process may be put to use directly in its dry state, without requiring such preliminary additional processes as soaking, steaming, roasting, liquefying etc. And, the material can be fermented well even by single-stage fermentation process. Consequently, it is possible to simplify the manufacturing process and to improve the manufacturing efficiency and energy saving.

(Embodiment 2)

Next, industrial alcohol as another example of fermented products was manufactured from tapioca.

First, like the Embodiment 1 described above, starch grain material obtained by pulverizing tapioca was subjected to the microwave irradiating process so that the material after the microwave irradiating process would obtained moisture content of about 5% or lower. Then, to the resultant dry starch grain material after the microwave irradiation, water, crude enzyme and culture solution containing alcohol yeast were added and this mixture was maintained at 30° C., whereby industrial alcohol was produced.

Separately, as a comparison example, the starch grain material obtained by pulverizing tapioca was further pulverized and liquefied with liquefying amylase at a high temperature of 95° C. This material was then saccharized by addition of saccharogenic amylase thereto at 60° C. This was cooled and added with yeast. Then, the resultant mixture was maintained at 33° C., whereby industrial alcohol was produced.

Comparison of alcohol yields of the above examples revealed that the invention's processing method provided a higher alcohol yield of 422.9 to 484.5 (100% Alc. L/t) than the yield 382.5 to 468.0 (100% Alc. L/t) in the comparison example. Hence, it was confirmed that in the case of manufacturing method of industrial alcohol by such fermenting method too, the inventions processing method achieves improvement in the material utilization factor.

Further, in the case of the manufacture of industrial alcohol by the fermentation method too, when the starch grain material processed by the invention's method is employed, such additional preliminary processes as liquefying and saccharifying are not necessary. Therefore, some steps of the manufacturing process may be omitted and significant reduction in the energy required for such steps is made possible. So, the total energy conservation is possible.

The foregoing embodiments relate to cases of brewing refined Japanese sake and to manufacture of industrial alcohol from tapioca as examples of fermented products. In addition to these, the invention's processing method may be employed also for producing starch grain materials for use in manufacture of liquor as another example of fermented products from barley, rye, potatoes, etc. and manufacture of other fermented products such as vinegar, soy sauce, miso (i.e. fermented soybean paste), from white rice, wheat, beans etc. In such cases too, by implementing the invention's method, the material utilization factor may be improved.

Further, in the foregoing embodiments, the starch grain materials processed by the invention's methods are subjected directly to the subsequent fermenting process for manufacturing fermented products. Instead, these materials may be subjected to some additional processes prior to the fermenting process. And, in the fermenting process, any conventional technique may be employed, depending on the kind of starch grain material employed and the type of the fermented product to be obtained.

The present invention may be embodied in other form than described above. Various modifications and changes will be obvious to those skilled in the art without departing from the essential spirit of the invention. The disclosed embodiments are provided for the purpose of illustration of some specific examples only, not limiting the scope of the invention which scope is set forth in the appended claims.

What is claimed is:

1. A method of processing starch grain material for use in a fermenting process subsequently thereto, wherein prior to subjecting the material to the fermenting step, the material is subjected to a microwave irradiating step, and wherein the microwave irradiating step is effected on the starch grain material which is in a dry condition storable at a room temperature with simultaneous application of hot air current thereto.

2. The method according to claim 1, wherein the starch grain material comprises rice grains and at least a portion of the rice grains are used directly as sake-brewing rice without being subjected to a water-soaking step, steaming step, liquefying step or roasting step.

3. The method according to claim 1, wherein the starch grain material comprises starch grain material for koji, and this koji material is mixed with water containing koji mold spores to a moisture content of 25 to 40% and the resultant mixture is adjusted to a temperature suitable for growth of the koji mold spores so as to obtain koji.

4. A method of manufacturing a fermented product, comprising:
a microwave irradiating step for irradiating microwave to dry starch grain material storable at a room temperature with simultaneous application of hot air current thereto; and
a fermenting step for fermenting the starch grain material obtained from the microwave irradiating step, thereby to obtain the fermented product.

5. The method according to claim 4, wherein the starch grain material comprises rice grains and at least a portion of the rice grains are used directly as sake-brewing rice without being subjected to a water-soaking step, steaming step, liquefying step or roasting step.

6. The method according to claim 4, wherein the starch grain material comprises starch grain material for koji, and this koji material is mixed with water containing koji mold spores to a moisture content of 25 to 40% and the resultant mixture is adjusted to a temperature suitable for growth of the koji mold spores so as to obtain koji.

7. A processing apparatus for processing starch grain material before the material is subjected to a fermenting process subsequent thereto, the apparatus comprising:
a hot air blower capable of feeding hot air to the material; and
a microwave irradiating device capable of irradiating microwave to the material while the hot air blower is feeding the hot air to the material simultaneously.
